(19) United States
(12) Patent Application Publication
(10) Pub. No.: US 2013/0273433 A1
(43) Pub. Date: Oct. 17, 2013

(54) SILICON/CARBON COMPOSITE MATERIAL, METHOD FOR THE SYNTHESIS THEREOF AND USE OF SUCH A MATERIAL

(71) Applicants: Severine Jouanneau-si Larbi, Sillans (FR); Carole Pagano, Bresson (FR)

(72) Inventors: Severine Jouanneau-si Larbi, Sillans (FR); Carole Pagano, Bresson (FR)

(73) Assignee: RENAULT S.A.S., Boulogne Billancourt (FR)

(21) Appl. No.: 13/978,037

(22) PCT Filed: Jan. 3, 2012
(86) PCT No.: PCT/FR12/00003

§ 371 Date: Jul. 2, 2013

(30) Foreign Application Priority Data
Jan. 7, 2011 (FR) 1100058

(51) Int. Cl. H01M 4/36

(52) U.S. Cl. CPC H01M 4/364
USPC 429/231.8; 252/502

(57) ABSTRACT

The invention relates to a silicon/carbon composite material, to a method for the synthesis thereof and to the use of such a material. The silicon/carbon composite material is formed by an aggregate of silicon particles and of carbon particles, in which the silicon particles and the carbon particles are dispersed. The carbon particles are formed by at least three different carbon types, a first type of carbon being selected from among non-porous spherical graphites, a second type of carbon being selected from among non-spherical graphites and a third type of carbon being selected from among porous electronically-conductive carbons. The first and second carbon types each have a mean particle size ranging between 0.1 μm and 100 μm and the third carbon type has a mean particle size smaller than or equal to 100 nanometers.

### BACKGROUND OF THE INVENTION

The invention relates to a silicon/carbon composite material formed of an aggregate of silicon particles and of carbon particles, in which the silicon particles and the carbon particles are dispersed.

The invention also relates to a method for the synthesis thereof and to the use of such a material.

### STATE OF THE ART

Lithium accumulators are more and more used as an autonomous power source, in particular in portable equipment. Such a tendency can be explained by the continual improvement of the performance of lithium accumulators, especially with mass and volume energy densities much greater than those of conventional nickel-cadmium (Ni—Cd) and nickel-metal hydride (Ni-MH) accumulators.

Carbon-based materials, in particular, graphite, have been successfully developed and widely commercialized as electrochemically active electrode materials, in particular, for lithium accumulators. Such materials have a particularly high performance due to their lamellar structure enabling a good intercalation and deintercalation of lithium and to their stability during the different charge and discharge cycles. However the theoretical specific capacity of graphite (372 mA/g) remains much lower than that of metal lithium (4000 mA/g).

Certain metals capable of incorporating lithium have appeared as promising alternatives to carbon. In particular, with a theoretical capacity estimated as being 3578 mAh/g (for Si→Li_{3,75}Si), silicon is an advantageous alternative to carbon. However, currently, a viable operation of silicon-based electrodes cannot be envisaged since lithium accumulators containing such electrodes have integrity problems inherent to the presence of silicon. Indeed, during the charge, lithium ions are implied in the forming of a protective passivation layer and in the forming of a Li₅Si₄ alloy with silicon by electrochemical reaction. As the alloy is being formed, electrode volume increases, possibly by up to 300%. Such a strong volume expansion is followed by a contraction during the discharge due to the deinsertion of the electrode lithium. Thus, the volume expansion of silicon particles during the accumulator charge results in a loss of integrity of the electrode causing both a loss of electronic percolation but also a loss of lithium associated with the forming of a passivation layer on the new created surfaces. These two phenomena induce a significant loss of the cycling irreversible capacity of the accumulator.

Recently, silicon/carbon composites, in which silicon is dispersed in a carbonaceous matrix have been provided. Such an active material for a lithium accumulator electrode would enable to maintain the electrode integrity after several charge-discharge cycles.

Several methods for manufacturing such silicon/carbon composites have been provided in literature, in particular, methods implementing energetic milling and/or chemical vapor deposition techniques (CVD).

As an example, document EP-A-1205989 describes a method for manufacturing a silicon/carbon composite material having a double structure formed of a porous core with an external surface covered with a coating layer. The method comprises a first step of forming of a silicon/carbon core by milling of a powder containing silicon particles and particles of a type of carbon, followed by a granulation, and a second step of coating of the silicon/carbon core with a carbon layer. The coating is obtained by CVD from a carbon source organic compound at the surface of the silicon/carbon core, followed by a carbonization between 900 and 1200° C. The carbon forming the silicon/carbon core is selected from among carbons having a resistivity smaller than or equal to 1.0 Ω·cm, for example, carbon black, acetylene black, graphites, coke or charcoal. The percentage of silicon in the silicon/carbon core ranges between 10% and 90% by weight, preferably between 40 and 90%.

Document CN-A-1913200 also provides a silicon/carbon electrode composite material, formed by a spherical core having its external surface covered with a carbon-based coating. The core is obtained from a mixture comprising between 1 and 50% by weight of silicon particles and between 50 and 99% by weight of a graphite or of a mixture of graphites. The coating amounts to from 1 to 25% by weight of the silicon/carbon composite material and comprises between 0.5 and 20% of a pyrolytic carbon and between 0.5 and 5% of an electronically-conductive carbon. Unlike what is disclosed in document EP-A-1205989, the silicon/carbon core of the silicon/carbon composite material is formed by simple mixture of silicon powders and graphites, with no milling. The silicon/carbon core is then bonded to an organic carbon source compound by a second step where the silicon/carbon core and the organic compound are simultaneously mixed and milled and then dried. The silicon/carbon core coated with the carbon-based coating is obtained by carbonization at a temperature ranging between 450° C. and 1500° C., to form a pyrolytic carbon coating, after which the electronic conductive carbon is mixed to incorporate the conductive carbon into said coating.

The methods described in literature however remain difficult to implement and expensive, for a performance and a mechanical hold of active materials still insufficient to enable to envisage a viable operation.

### SUMMARY OF THE INVENTION

The invention aims at a silicon/carbon composite material which at least partly overcomes the disadvantages of the prior art.

In particular, the invention aims at a silicon/carbon composite material having a high electric conductivity. More specifically, the invention aims at a silicon/carbon composite material having an improved electrochemical performance.

The invention also aims at a synthesis method of such a composite material which would be easy to implement and inexpensive.

According to the invention, this aim is achieved by the fact that the carbon particles are formed of at least three different types of carbon, a first carbon type being selected from among non-porous spherical graphites, a second carbon type being selected from among non-spherical graphites, and a third carbon type being selected from among porous electronically-conductive carbons, by the fact that the first and second carbon types each have a mean particle size ranging between 0.1 μm and 100 μm and by the fact that the third carbon type has a mean particle size smaller than or equal to 100 nm.

According to a development of the invention, the carbon particles are formed by graphite particles in the form of microbeads, of graphite in lamellar form, and of carbon black, with a mass ratio of 1/3:1/3:1/3.

Such a silicon/carbon composite material is advantageously used as an electrochemically active material of an electrode, preferably, of an electrode of a lithium accumulator.

### BRIEF DESCRIPTION OF THE DRAWINGS

Other advantages and features will become more clearly apparent from the following description of particular embodiments of the invention given for non-restrictive example purposes only and represented by the single accompanying drawing, where

FIG. 1 schematically shows, in cross-section view, a silicon/carbon composite material according to a specific embodiment of the invention.

### DESCRIPTION OF PARTICULAR EMBODIMENTS

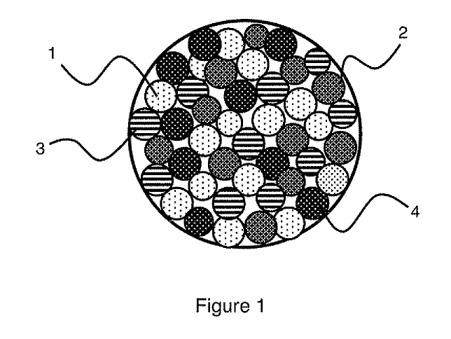

According to a specific embodiment shown in FIG. 1, a silicon/carbon composite material is formed of an aggregate of silicon particles 1 and of carbon particles. Composite material means a heterogeneous solid material obtained by associating at least two phases having complementary respective qualities to form a material having an improved general performance. Aggregate means an assembly of particles which are strongly and intimately bonded to form a very stable unit.

The silicon/carbon composite material advantageously comprises between 10% and 50% by mass of silicon particles 1 and between 50% and 90% by mass of carbon particles, the sum of the mass percentages of the silicon particles and of the carbon particles being equal to 100%. Except for possible impurities, the silicon/carbon composite material is accordingly only formed of carbon and of silicon.

As shown in FIG. 1, silicon particles 1 and the carbon particles are dispersed in the aggregate, advantageously, homogeneously, so that each silicon particle 1 is at least partly covered with carbon particles or, advantageously, surrounded with carbon particles. Silicon particles 1 are distributed among the carbon particles so that the carbon particles preferably form a matrix for silicon particles 1.

Silicon particles 1 advantageously have a nanometric size. Silicon particles 1 preferably have a mean particle size smaller than or equal to 1 μm. Advantageously, silicon particles 1 mainly have a spherical shape. However, plate-like particles may also be envisaged.

The carbon particles are formed of at least three different types of carbon. “Different types of carbon” means carbons differing by their allotropic structure, their shape and/or their particle size. The carbon particles are formed of at least first, second and third different and complementary types of carbon, respectively 2, 3, and 4, to create a carbonaceous matrix promoting percolation and electronic diffusion within the silicon/carbon composite material.

First carbon type 2 is selected from among spherical non-porous graphites. First carbon type 2 preferably is a graphite in the form of microbeads, for example MCMB (“meso-carbon microbeads”). First carbon type 2 advantageously has a specific surface area ranging between 0.1 m²/g and 3 m²/g.

Second carbon type 3 is selected from among non-spherical graphites. Second carbon type 3, preferably, is a graphite in lamellar form. Second carbon type 2 has a specific surface area ranging between 5 m²/g and 20 m²/g.

The first and second carbon types, respectively 2 and 3, are submicrometric to micrometric carbons. The first and second carbon types, respectively 2 and 3, each have a mean particle size ranging between 0.1 μm and 100 μm.

Third carbon type 4 is selected from among porous electronically-conductive graphites. Third carbon type 4 is a nanometric carbon having a mean particle size smaller than or equal to 100 nm. Third carbon type 4, advantageously, has a specific surface area greater than or equal to 50 m²/g. Third carbon type 4 preferably is a carbon black, for example the Super P™ carbon black. The mass percentage of each carbon type ranges between 5% and 90%, preferably between 10% and 80%, of the total carbon particle mass in the silicon/carbon composite material.

According to a specific embodiment, the respective mass percentages of the different carbon types in the silicon/carbon composite material may advantageously be identical.

According to a preferred embodiment, the carbon particles are only formed of the first, second and third types of carbon, respectively, 2, 3, and 4. The carbon particles may for example be formed by particles of graphite 2 in the form of microbeads, of graphite 3 in lamellar form, and of carbon black 4, with a mass ratio of 1/3:1/3:1/3.

The above-described silicon/carbon composite material may be directly obtained by a synthesis method described hereafter only involving elementary conventional steps, which are simple to implement.

According to a first specific embodiment, a synthesis method of the above-described silicon/carbon composite material only comprises the mechanical milling of a mixture of silicon particles and of carbon particles, initially in the form of powders.

Advantageously, the milling is performed in a liquid solvent and the milling step is followed by a drying step to remove the liquid solvent.

The initial silicon particles appear in the form of a powder of thin particles, advantageously of nanometric size. The silicon particles preferably have a mean particle size smaller than or equal to 1 μm.

The initial carbon particles appear in the form of a powder of thin particles formed of at least first, second and third types of carbon each having a different allotropic structure, particle shape and/or size.

The first carbon type is selected from among spherical non-porous graphites. The first carbon type preferably is a graphite in the form of microbeads, for example MCMB. The first carbon type advantageously has a specific surface area ranging between 0.1 m²/g and 3 m²/g.

The second carbon type is selected from among non-spherical graphites. The second carbon type preferably is a graphite in lamellar form. The second carbon type has a specific surface area ranging between 5 m²/g and 20 m²/g.

The first and second carbon types are carbons with a submicrometric to micrometric size. The first and second carbon types have a mean particle size ranging between 0.1 μm and 100 μm.

The third carbon type is selected from among nanometric porous electrically-conductive carbons, having a mean particle size smaller than or equal to 100 nm. The third carbon type advantageously has a specific surface area greater than or equal to 50 m²/g. The third carbon type preferably is a carbon black, for example Super P™ carbon black.

The initial silicon particles and carbon particles may comprise impurities by proportions capable of ranging up to 5%, and preferably smaller than 2%. However, the mass content of silicon or carbon, respectively, of the silicon particles or of the carbon particles, should remain high to maintain the electrochemical performance of the silicon/carbon composite material. Similarly, the nature of the impurities should not alter the mechanical and/or electrochemical properties of the silicon/carbon composite material.

The initial silicon particles and the different types of initial carbon may be introduced, simultaneously or separately, during the milling step, in the form of one or several successive loads introduced into a mill.

The mass percentage of each carbon type introduced during the milling advantageously ranges between 5% and 90%, preferably between 10% and 80%, of the total carbon particle mass in the initial mixture of powders.

The respective mass percentages of the different carbon types in the initial powder mixture may advantageously be identical. The carbon particles are preferably only formed of the first, second, and third carbon types.

The milling step is for example carried out by introducing into the mill an initial mixture of powders of the silicon particles and of the carbon particles, by adding the liquid solvent to form a suspension, by milling said suspension, and by evaporating the liquid solvent to obtain the silicon/carbon composite material. As a variation, a dry milling is also possible.

The initial powder mixture preferably comprises between 10% and 50% by mass of silicon particles and between 50% and 90% by mass of carbon particles, the sum of the mass percentages of the silicon particles and of the carbon particles being equal to 100%.

As an example, the carbon particles are formed by the mixing of a graphite in the form of microbeads having a specific surface area ranging between 0.1 m²/g and 3 m²/g, of a graphite in lamellar form having a specific surface area ranging between 5 m²/g and 20 m²/g, and of a carbon black having a specific surface area greater than or equal to 50 m²/g. The mass ratio of each carbon type represents to one third of the total mass of the carbon particles introduced in the milling step.

The liquid solvent is selected to be inert with respect to the silicon particles and to the carbon particles. The liquid solvent is advantageously selected among alkanes, preferably aromatic alkanes such as hexane. The presence of a liquid solvent improves the homogeneity of the mixture and helps obtaining a silicon/carbon composite material free of clusters, in which the silicon particles and the particles or the different types of carbon are dispersed.

After the mechanical milling step, the liquid solvent is conventionally eliminated by drying. The previously-described silicon/carbon composite material is obtained after evaporation of the liquid solvent according to any known method, for example, by drying in an oven at a 55° C. temperature for from 12 to 24 hours.

Traces of liquid solvent may remain in the silicon/carbon composite material thus obtained after drying. However, the liquid solvent residue is not significant and does not exceed 1% by mass of the total mass of the silicon/carbon composite material.

According to a second specific embodiment, a synthesis method is identical to the synthesis method according to the first embodiment except for the fact that it comprises an additional step of thermal post-treatment of the silicon/carbon composite material performed after the mechanical milling step to consolidate the silicon/carbon composite material. The post-processing strengthens the cohesion of silicon particles and of carbon particles together within the silicon/carbon composite material.

The synthesis method is advantageously comprised of the following successive steps only:
forming of the silicon/carbon composite material by mechanical milling in the previously-described liquid solvent of the above-described mixture of silicon particles and of carbon particles, initially in the form of a powder,
drying to eliminate the liquid solvent, and
thermal post-treatment at a temperature ranging between 600° C. and 1,100° C., preferably at 1,000° C., for a short time no longer than 4 h, preferably ranging between 15 min and 4 h.

The thermal post-treatment is preferably performed under a controlled or reducing atmosphere, for example, under an argon or hydrogen atmosphere.

Synthesis methods according to the first and second previously-described embodiments are particularly advantageous over those of prior art since they enable to obtain a silicon/carbon composite material having improved electrochemical properties, in a limited number of steps and without requiring covering the composite material with a carbon coating. The method steps are conventional, reproducible and simple to implement. Thus, the method according to the invention enables to avoid the coating step present in prior art methods while enabling to perfect the electronic percolation system within the silicon/carbon composite material.

The above-described conductive silicon/carbon composite material is particularly well adapted to a use as an electrochemically-active electrode material. Electrochemically-active electrode material here means a material taking part in the electrochemical reactions implemented within the electrode.

The silicon/carbon composite material may be used as an electrochemically active material of an electrochemical system with a non-aqueous or even aqueous material.

The silicon/carbon composite material is advantageously adapted to a use as an electrochemically active electrode material of a lithium accumulator.

An electrode may be made of a dispersion formed, according to any known method, by the above-described silicon/carbon composite material and a conductive additive, for example, a conductive carbon.

As a variation, an electrode may be made of a dispersion formed, according to any known method, by the above-described silicon/carbon composite material and a binder intended to ensure the mechanical cohesion, once the solvent has been evaporated.

The binder conventionally is a polymeric binder selected from among polyesters, polyethers, polymer derivatives of methylmethacrylate, acrylonitrile, caboxymethyl cellulose and derivatives thereof, latexes of butadiene styrene type and derivatives thereof, polyvinyl acetates or polyacrylic acetate and vinylidene fluoride polymers, for example, polyvinylidene difluoride (PVdF).

According to a specific embodiment, a battery comprises at least one negative electrode containing the silicon/carbon composite material described hereabove and a positive lithium ion source electrode. The battery advantageously comprises a non-aqueous electrolyte.

As known, the non-aqueous electrolyte may for example be formed of a lithium salt comprising at least one Li⁺ cation selected from among:
lithium bis[(trifluoromethyl)sulfonyl]imide (LiN(CF₃SO₂)₂), lithium trifluoromethane sulfonate (LiCF₃SO₃), lithium bis(oxalato)borate (LiBOB), lithium bis(perfluoroethylsulfonyl)imide (LiN(CF₃CF₂SO₂)₂),
compounds having formula LiClO₄, LiAsF₆, LiPF₆, LiBF₄, LiI, LiCH₃SO₃ or LiB(C₂O₄)₂ and,
fluorinated compounds having formula LiR_{F}SO₃R_{F}, LiN(R_{F}SO₂)₂, or LiC(R_{F}SO₂)₃ where R_{F} is a group selected from a fluorine atom and a perfluoroalkyl group comprising from one to eight carbon atoms.

The lithium salt is preferably dissolved in a solvent or a mixture of aprotic polar solvents, for example, selected from among ethylene carbonate (noted “EC”), propylene carbonate, dimethylcarbonate, diethylcarbonate (noted “DEC”), methylethylcarbonate.

### EXAMPLES

### Features of the Initial Carbons

Carbon

First carbon type: Spherical non-porous MCMB (“Meso-Carbon MicroBeads”) 2528 graphite, sold by Showa Denko.
Second carbon type: non-spherical SFG15 graphite, in the form of flakes, sold by Timcal.
Third carbon type: carbon of Super P™ type sold by Timcal.

The features of the first, second, and third carbon types as well as of silicon are listed in table 1 hereabove.

TABLE 1

| | | | MCMB | | SFG15 | | Super P ™ | |
|---|---|---|---|---|---|---|---|---|
| | Silicon | | carbon | | carbon | | carbon | |
| Particle shape | spheres | | spheres | | flakes | | porous | |
| Specific surface area (BET) | 80 | | 2 | | 9.5 | | 60 | |
| (m²/g) | | | | | | | | |
| Mean particle size | 100 | nm | 25 | μm | 15 | μm | 40 | nm |
| Expected practical reversible | 3600 | mAh/g | 320 | mAh/g | 360 | mAh/g | 70 | Ah/g |
| capacity (mAh/g) | | | | | | | | |

Two silicon/carbon composite materials, 1-Si/3C and 2-Si/3C, comprising three different types of carbon, have been synthesized according to a same synthesis method and in strictly identical conditions.

Further, three other silicon/carbon composite materials comprising less than three different carbon types have been formed, for comparison purposes, according to an operating mode and in synthesis conditions identical to those used for silicon/carbon composite materials 1-Si/3C and 2-Si/3C. Silicon/carbon composite materials 3-Si/2C and 4-Si/2C only comprise two different types of carbon and silicon/carbon composite material 5-Si/1C comprises a single type of carbon.

### Example 1

### Synthesis of Silicon/Carbon Composite Material 1-Si/3C

Composite material 1-Si/3C is obtained by mechanical milling in a Retsch ball mill (diameter 8 mm), of a mixture of 1.80 g of silicon and 4.20 g of carbon particles (Si/C mass ratio of 30/70) in 150 mL of hexane. 4.20 g of carbon particles correspond to a mixture of 1.40 g of spherical MCMB 2528 graphite, 1.40 g of powder of lamellar SFG15 graphite, and 1.40 g of powder of electronically-conductive Super P™ carbon (mass ratio 1/3:1/3:1/3). After drying at 20° C. for 240 min, 6 g of silicon/carbon composite material 1-Si/3C are obtained. Composite material 1-Si/3C is thermally processed under an argon flow at a temperature of 1000° C. for 4 hours.

### Example 2

### Synthesis of Silicon/Carbon Composite Material 2-Si/3C

Composite material 2-Si/3C is obtained according to the same operating mode as in example 1, except for the respective mass ratios of the three carbon types. 8.40 g of carbon particles are obtained by mixture of 6.72 g of spherical MCMB 2528 graphite, 0.84 g of powder of lamellar SFG15 graphite and 0.84 g of powder of electronically-conductive Super P™ carbon (mass ratio 80:10:10).

### Example 3

### Synthesis of Silicon/Carbon Composite Material 3-Si/2C

Composite material 3-Si/2C is obtained according to the same operating mode as in example 1, except for the fact that only two carbon types are used. 8.40 g of carbon particles are formed by a mixture of 6.72 g of powder of spherical MCMB 2528 graphite and 1.68 g of powder of lamellar SFG15 graphite (mass ratio of 80:20).

### Example 4

### Synthesis of Silicon/Carbon Composite Material 4-Si/2C

Composite material 4-Si/2C is obtained according to the same operating mode as in example 1, except for the fact that only two carbon types are used. 8.41 g of carbon particles are formed by a mixture of 6.72 g of powder of spherical MCMB 2528 graphite and 1.69 g of powder of electronically-conductive Super P™ carbon (mass ratio of 80:20).

### Example 5

### Synthesis of Silicon/Carbon Composite Material 5-Si/C

Composite material 5-Si/C is obtained according to the same operating mode as in example 1, except for the fact that only one carbon type is used. 8.40 g of carbon particles are formed by 8.40 g of powder of spherical MCMB graphite 2528.

### Electrochemical Performance Measurement

Five lithium accumulators of “button cell” type have been formed from the five silicon/carbon composite materials of examples 1 to 5 in strictly identical synthesis conditions and then tested to compare their electrochemical performance.

### Preparation of a “Button Cell” Type Lithium Accumulator

The “button cell” type lithium accumulator is conventionally formed from a negative lithium electrode, from a positive electrode containing the silicon/carbon composite material and from a polymer Celgard-type separator.

The negative electrode is formed by a circular film having a 14-mm diameter and a 100-μm thickness, deposited on a stainless steel disk used as a current collector. The separator is soaked with a liquid electrolyte containing LiPF6 at a 1-mol/l concentration in a mixture of EC/DEC with a 1/1 solvent volume ratio.

The positive electrode is formed from the silicon/carbon composite material. An ink is obtained by mixing 80% by mass of the silicon/carbon composite material, 10% by mass of carbon and 10% by mass of polyvinylidene difluoride (PVdF) forming the binder, the mass percentages being calculated with respect to the total weight of the obtained ink. The ink is then deposited on an aluminum strip having a 20-μm thickness, forming the current collector, under a doctor blade at a 100-μm thickness and then dried at 80° C. for 24 h. The obtained film is pressed under a 10-T pressure and then cut in the form of a disk having a 14-mm diameter to form the positive electrode of the “button cell” type lithium accumulator.

### “Button Cell” Type Lithium Accumulator Testing

The five “button cell” type lithium accumulators have been tested at a 20° C. temperature, in galvanostatic mode at a C/10 rate between a potential of 1.5 V and 3 V vs. Li⁺/Li.

For each “button cell” type lithium accumulator, the practical reversible capacity returned in discharge mode Qₚ is measured and compared with the calculated practical reversible capacity Q_{c}. The practical reversible capacity returned in discharge mode Qₚ is measured with an error margin of ±1%.

Practical reversible capacity Qₚ of the silicon/carbon composite material is calculated from equation (1) described hereafter, based on the expected practical reversible capacities Qₐₜₜ^{Si} and Qₐₜₜ^{Ci}, respectively, of silicon and of the different carbon types, and on their respective mass percentage in the silicon/carbon composite material.

Q_{c}% Si*Qₐₜₜ^{Si}+Σ% Cᵢ*Qₐₜₜ^{Ci} (1)

where Cᵢ corresponds to a carbon type, and
Qₐₜₜ^{Si} and Qₐₜₜ^{Ci} are the expected practical reversible capacitances, respectively of silicon and of the considered carbon type Cᵢ.

Table 2 hereafter lists the results obtained from the “button cell” type lithium accumulators comprising an electrode made from the silicon/carbon composite materials of examples 1 to 5.

TABLE 2

| | | m_{Si}/ | m_{MCMB}/ | m_{SFG15}/ | m_{SuperP}/ | | | |
|---|---|---|---|---|---|---|---|---|
| | | (Σm_{Ci+}m_{Si}) | Σm_{Ci} | Σm_{Ci} | Σm_{Ci} | Q_{c} | Qₚ | |
| Example | Ref. | (%) | (%) | (%) | (%) | (mAh/g) | (mAh/g) | Qₚ/Q_{c} |
| 1 | 1-Si/3C | 30/70 | 33.33 | 33.33 | 33.33 | 1253 | 1250 | 0.99 |
| 2 | 2-Si/SC | 30/70 | 80 | 10 | 10 | 1289 | 1175 | 0.91 |
| 3 | 3-Si/2C | 30/70 | 80 | 20 | 0 | 1309 | 1060 | 0.81 |
| 4 | 4-Si/2C | 30/70 | 80 | 0 | 20 | 1269 | 1100 | 0.87 |
| 5 | 5-Si/C | 30/70 | 100 | 0 | 0 | 1304 | 1150 | 0.88 |

The “button cell” type lithium accumulators can be ranked according to the obtained values of Qₚ. The following ranking of the examples is obtained:

1>2>5>4>3

By comparing the results of the practical reversible capacities with the calculated practical reversible capacities, that is, according to ratio Qₚ/Q_{c}, the same ranking is obtained.

Thus, the obtained results highlight the improved performance of “button cell” type lithium accumulators having a positive electrode formed with silicon/carbon composite materials 1-Si/3C and 2-Si/3C.

Such results are all the more unexpected as, with a low expected practical reversible capacity Qₐₜₜ^{CSuperP} of 70 mAh/g, Super P carbon black forming the third carbon type is assumed to insert little capacity. It would accordingly have been expected to observe a decrease of practical reversible capacity Qₚ for examples 1 and 2. Now, surprisingly, the association of at least three different carbon types results in improving the electrochemical performance of the silicon/carbon composite material.

Similarly, the comparison of the results obtained at examples 2 and 3 shows that the addition of SuperP carbon black only is not sufficient to obtain an effect on the electrochemical performance of the silicon/carbon composite material. A synergic effect is observed on the electrochemical performance only by combination of at least three complementary carbon types, a non-porous spherical micrometric graphite, a non-spherical micrometric graphite and a porous electronically-conductive nanometric carbon.

It can further be observed that the combination of two different carbon types only is not sufficient and may even be prejudicial. Indeed, the practical reversible capacities Qₚ obtained at examples 3 and 4 are lower than practical reversible capacity Qₚ of example 5 containing the MCMB spherical carbon only.

The presence of at least three carbon types creates a three-dimensional network improving the electronic percolation and the electronic conduction of the silicon/carbon composite material.

As illustrated in FIG. 1, the association of at least three different carbons within the silicon/carbon composite material enables to form a carbonaceous matrix having a specific morphology and porosity, in which the particles or the silicon grains are surrounded with the particles or grains of the different carbon types. The association of the different carbon types forms an environment around the silicon particles which promotes the electronic conduction between the silicon particles or grains.

Further, the interaction between the silicon particles and the carbonaceous matrix formed by the different carbon types results in a phase stabilization and a good cycling resistance.

Although it has no carbon coating, the silicon/carbon composite material according to the invention is particular advantageous over prior art silicon/carbon composite materials since it may be obtained a method which is inexpensive and simple to implement while maintaining a good electrochemical performance.

1-18. (canceled)

19. Silicon/carbon composite material formed of an aggregate of silicon particles and of carbon particles, in which the silicon particles and the carbon particles are dispersed, wherein the carbon particles are formed of at least three different carbon types, a first carbon type being selected from among non-porous spherical graphites, a second carbon type being selected from among non-spherical graphites and a third carbon type being selected from among porous electronically-conductive carbons, and in that the first and second carbon types each have a mean particle size ranging between 0.1 μm and 100 μm and in that the third carbon type has a mean particle size smaller than or equal to 100 nm.

20. Composite material according to claim 19, wherein the mass percentage of each carbon type ranges between 5% and 90% of the total carbon particle mass.

21. Composite material according to claim 19, wherein the respective mass percentages of the different carbon types are identical.

22. Composite material according to claim 19, wherein the carbon particles are only formed of the first, second, and third carbon types.

23. Composite material according to claim 19, wherein the first carbon type is a graphite in the form of microbeads.

24. Composite material according to claim 19, wherein the second carbon type is a graphite in lamellar form.

25. Composite material according to claim 19, wherein the third carbon type is a carbon black.

26. Composite material according to claim 19, wherein the first carbon type has a specific surface area ranging between 0.1 m²/g and 3 m²/g.

27. Composite material according to claim 19, wherein the second carbon type has a specific surface area ranging between 5 m²/g and 20 m²/g.

28. Composite material according to claim 19, wherein the third carbon type has a specific surface area greater than or equal to 50 m²/g.

29. Composite material according to claim 19, wherein the silicon particles have a mean particle size smaller than or equal to 1 μm.

30. Composite material according to claim 19, wherein the carbon particles are formed by graphite particles in the form of microbeads, of graphite in lamellar form and of carbon black, with a mass ratio of 1/3:1/3:1/3.

31. Method of synthesis of a silicon/carbon composite material according to claim 19, wherein the method comprises a step of mechanical milling of a mixture of silicon particles and of carbon particles, initially in the form of a powder, the carbon particles being formed of at least three different carbon types, a first carbon type selected from among non-porous spherical graphites, a second carbon type selected from among non-spherical graphites, and a third carbon type selected from among porous electronically-conductive carbons, the first and second carbon types each having a mean particle size ranging between 0.1 μm and 100 μm and the third carbon type having a mean particle size smaller than or equal to 100 nm.

32. Method according to claim 31, wherein the method comprises the successive steps of:
mechanical milling of the mixture of silicon particles and of carbon particles, initially in the form of a powder, and
thermal post-processing at a temperature ranging between 600° C. and 1100° C. for a time period ranging between 15 min and 4 h.

33. Method according to claim 31, wherein it is comprised of the successive steps of:
mechanical milling in a liquid solvent of the mixture of silicon particles and of carbon particles, initially in the form of a powder,
drying to remove the liquid solvent, and
thermal post-processing at a temperature ranging between 600° C. and 1100° C. for a time period ranging between 15 min and 4 h.

34. Method according to claim 33, wherein the liquid solvent is selected from among alkanes.

35. An electrochemically active electrode material, comprising the silicon/carbon composite material according to claim 19.

36. A lithium accumulator electrode comprising the silicon/carbon composite material according to claim 19.
